(19) United States
(12) Patent Application Publication
(10) Pub. No.: US 2009/0233127 A1
(43) Pub. Date: Sep. 17, 2009

(54) FUEL CELL SYSTEM

(75) Inventors: Kazumasa Ohya, Miyagi (JP); Kazuya Mori, Miyagi (JP); Kazuhisa Nagase, Miyagi (JP); Tsuyoshi Takemoto, Tokyo (JP); Toshiaki Nakazawa, Tokyo (JP); Takahisa Kitaguchi, Tokyo (JP); Takashi Manako, Tokyo (JP); Osamu Yamashita, Tokyo (JP); Hidekazu Kimura, Tokyo (JP); Hiroshi Kajitani, Tokyo (JP)

Correspondence Address: SUGHRUE MION, PLLC, 2100 PENNSYLVANIA AVENUE, N.W., SUITE 800, WASHINGTON, DC, 20037, US

(73) Assignees: NEC CORPORATION, TOKYO (JP); NEC TOKIN CORPORATION, MIYAGI (JP); NEC PERSONAL PRODUCTS LTD., TOKYO (JP)

(21) Appl. No.: 11/817,128

(22) PCT Filed: Feb. 24, 2006
(86) PCT No.: PCT/JP2006/303375

§ 371 Date: Nov. 19, 2007

(30) Foreign Application Priority Data
Feb. 25, 2005 (JP) 2005-049996
Jun. 6, 2005 (JP) 2005-165651

(51) Int. Cl. H01M 8/04

(52) U.S. Cl. 429/13; 429/22

(57) ABSTRACT

In a viewpoint of the invention, a fuel cell system includes a fuel cell configured to generate a electric power by using fuel; a first assisting power source; a protecting circuit connected to the first assisting power source and configured to detect a failure in the first assisting power source; an auxiliary unit configured to supply the fuel to the fuel cell; a control circuit configured to control the fuel cell and the auxiliary unit; a first power converter configured to drive the control circuit by using electric power from the first assisting power source; and a first synthesizing section configured to synthesize a first electric power from the fuel cell and a second electric power from the first assisting power source to supply a synthesized power to a load.

### TECHNICAL FIELD

The present invention relates to a fuel cell system including a fuel cell.

### BACKGROUND ART

A fuel cell is expected to be applied to automobiles and cellular phones as a portable power source requiring no charge. However, an internal resistance of the fuel cell is high in an existing technique so that it is impossible to supply a large amount of power instantaneously. For this reason, an assisting power source such as an electrical double layer capacitor is used. In addition, an auxiliary power source such as a secondary battery is used, for supplying electric power during an initial operation of a device for conveying fuel and until an output of the fuel cell stabilizes. Accordingly, a control unit for combining the fuel cell, the assisting power source and the auxiliary power source is required, and a control method thereof is variously studied.

For example, although down sizing of a fuel cell power source is required in a personal computer using a type of a fuel cell which directly oxidizes methanol, the peak power required for the personal computer sometimes cannot be supplied when only a down sized fuel cell is used. As a counter measure for such problems, provision of a high-capacity capacitor to an output stage of a fuel cell in a fuel cell system is suggested in Japanese Laid Open Patent Application (JP-P2002-32154A).

Further, in a fuel cell, electric power cannot be supplied at start-up until fuel is distributed to the whole of fuel cell. In addition, predetermined electrical power cannot be outputted when a body of the fuel cell is not hot. As a result, a direct methanol type fuel cell needs a power source used for a pump to convey the fuel, a fun, and the like. For such problems, a provision of the auxiliary power source to a fuel cell system is suggested in Japanese Laid Open Patent Application (JP-A-Heisei 11-176454).

Considering portability, a battery part has to be reduced in its size and its weight in fields of portable equipment. Consequently, it is required to commoditize an auxiliary power source for the peak power and an auxiliary power source for supplying an initial power at time of start-up, and not to request a complex manipulation for a user for that purpose.

In Japanese Laid Open Patent Application (JP-P2004-152741A), a technique for controlling power supply to an external load in the direct methanol type fuel cell is suggested. In addition, in Japanese Laid Open Patent Application (JP-P2004-265787A), a technique for stably supplying power to a load in the direct methanol type fuel cell is suggested.

FIG. 1 is a block diagram showing a configuration of a fuel cell system in a related art in which an auxiliary power source is replaceable. As shown in FIG. 1, main components in the fuel cell system of the related art are a fuel cell 101, an auxiliary power source pack 150, a driving section 105, a control circuit 110, an auxiliary unit 108, a charging circuit 104, and a connector 106. The connector 6 is a divisional type connector and the auxiliary power source pack 150 can be arbitrarily attached and detached. The auxiliary power source pack 150 is composed of a secondary battery 102 and a protecting circuit 107, and supplies electrical power through the connector 106 for a shortage of power from only the fuel cell 101. Since the secondary battery 102 used as the auxiliary power source has duration of life, the auxiliary power source pack 150 has to have a replaceable configuration. In consideration of safety in malfunction, the protecting circuit 107 is included in the pack 150.

When the secondary battery 102 has only one system of power supply as shown in FIG. 1, if an output of the secondary battery 102 is cut down by the protecting circuit 107 because of some malfunctions, the following problems will occur. Specifically, the control circuit 110 may wholly stop in a condition that the protecting circuit 107 is activated and the fuel cell 101 is not able to supply electric power, for example, in the middle of start-up of the fuel cell 101.

### DISCLOSURE OF INVENTION

Accordingly, an object of the present invention is to provide a fuel cell system in which an auxiliary unit is arranged and which is able to realize an optimal control depending on a condition of a fuel cell when an auxiliary power source is required.

In addition, another object of the present invention is to provide a fuel cell system, which can supply electric power always from an auxiliary power source other than a fuel cell not so as to shut off a control circuit.

In one exemplary aspect of the present invention, a fuel cell system includes a fuel cell for generating electric power by using fuel; a first assisting power source; a protecting circuit connected to the first assisting power source and configured to detect a failure in the first assisting power source; an auxiliary unit configured to supply the fuel to the fuel cell; a control circuit configured to control operations of the fuel cell and the auxiliary unit; a first electric power converter configured to drive the control circuit by the electric power from the first assisting power source; and a first synthesizing section configured to synthesize a first electric power from the fuel cell and a second electric power from the first assisting power source to supply to a load.

Here, the first assisting power source is a secondary battery, and a charging circuit may be further provided between the fuel cell and the protecting circuit for charging the secondary battery based on electric power from the fuel cell. The control circuit controls the charging circuit based on an output of the fuel cell.

In addition, the first assisting power source may be a primary battery.

In addition, the fuel cell system may further include a dummy load circuit connected to the output of the fuel cell; and a first switch circuit connected to the output of the fuel cell. When it is determined based on a dummy load circuit that the output of the fuel cell is within a predetermined range, the control circuit turns on the first switch circuit.

In addition, the dummy load circuit may include a heater for heating the fuel cell; and a second switch circuit connected between the output of the fuel cell and the heater. The control circuit controls ON/OFF of the second switch circuit based on a temperature of the fuel cell.

In addition, the fuel cell system may further include a second electric power converter for performing an electric power conversion on electric power from the first assisting power source to supply a second electric power to the first synthesizing section; and a third switch circuit provided in parallel to the second electric power converter to supply electric power from the first assisting power source as the second electric power to the first synthesizing section. The control circuit turns on the third switch circuit and turns off the second electric power converter, in a first predetermined period, and turns off the third switch circuit and turns on the second electric power converter, in a period other than the first predetermined period.

In addition, the control circuit may supply the electric power to the auxiliary unit. Or, the fuel cell system may further include a third electric power converter connected to an output of the first synthesis to supply electric power to the auxiliary unit through an electric power conversion.

In addition, it is preferable that the first assisting power source, the protecting circuit, and the first electric power converter constitute an electric power source pack which is detachably connected through a connector.

In addition, the fuel cell system may further include a DC power source, a charging circuit provided between the fuel cell and the protecting circuit to charge the secondary battery based on electric power from the fuel cell; a third electric power converter connected to an output of the first synthesizing section to supply electric power to the auxiliary unit through electric power conversion; a second synthesizing section connected to an input of the first synthesizing section and the DC power source to synthesize electric power from the fuel cell and electric power from the DC power source to supply to the charging circuit; and a third synthesizing section connected to the output of the first synthesizing section and the DC power source to synthesize electric power from the fuel cell and electric power from the direct current power source to supply to the third electric power converter. Or, the fuel cell system may further include the third electric power converter connected to the DC power source and the output of the first synthesizing section to supply electric power to the auxiliary unit through electric power conversion; and a third synthesizing section connected to the output of the first synthesizing section and the DC power source to synthesize electric power from the fuel cell and electric power from the direct current power source to supply to the third electric power converter.

In another aspect of the present invention, a control method of a fuel cell system may be achieved by: turning on a control circuit by a first assisting power source, by supplying electric power to a load from the first assisting power source under a control of the control circuit; by turning on the fuel cell in response to a cell-on instruction; by driving the auxiliary unit to supply fuel to the fuel cell; by determining whether an operation of the fuel cell is normal or not; by stopping a supply of electric power from the first assisting power source when it is determined that the operation of the fuel cell is normal; and by supplying electric power to the load from the fuel cell.

Here, a first fuel cell is a secondary battery, and the control method of the fuel cell system may be achieved further by charging the first assisting power source by using the charging circuit when it is determined by the control circuit that there is a margin in electric power supplied to the load from the fuel cell.

In addition, the control method of the fuel cell system may be achieved by determining whether the first assisting power source is fully charged or not in response to a cell-off instruction; by fully charging the first assisting power source when being not fully charged; by separating the fuel cell from the load; and stopping supply of fuel to the fuel cell.

### BRIEF DESCRIPTION OF DRAWINGS

FIG. 1 is a block diagram showing a configuration of a fuel cell system in a related art;

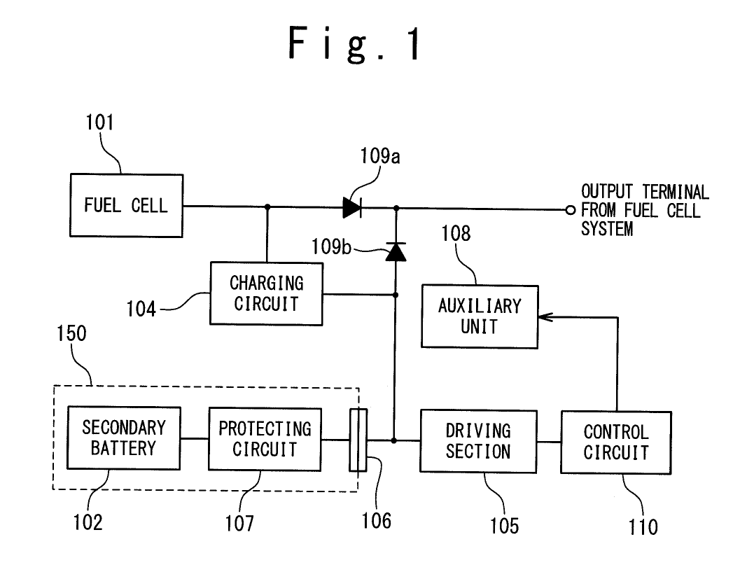

FIG. 2 is a block diagram showing a configuration of a fuel cell system according to a first exemplary embodiment of the present invention;

FIG. 3 is a block diagram showing a configuration of the fuel cell system according to a second exemplary embodiment of the present invention;

FIG. 4 is a flowchart showing an operation of the fuel cell system according to the first exemplary embodiment of the present invention;

FIG. 5 is a block diagram showing a configuration of the fuel cell system according to a third exemplary embodiment of the present invention;

FIG. 6 is a block diagram showing a configuration of the fuel cell system according to a fourth exemplary embodiment of the present invention; and

FIG. 7 is a block diagram showing a configuration of the fuel cell system according to a fifth exemplary embodiment of the present invention.

### BEST MODE FOR CARRYING OUT THE INVENTION

Hereinafter, a fuel cell system of the present invention will be described in detail with reference to the attached drawings.

### First Exemplary Embodiment

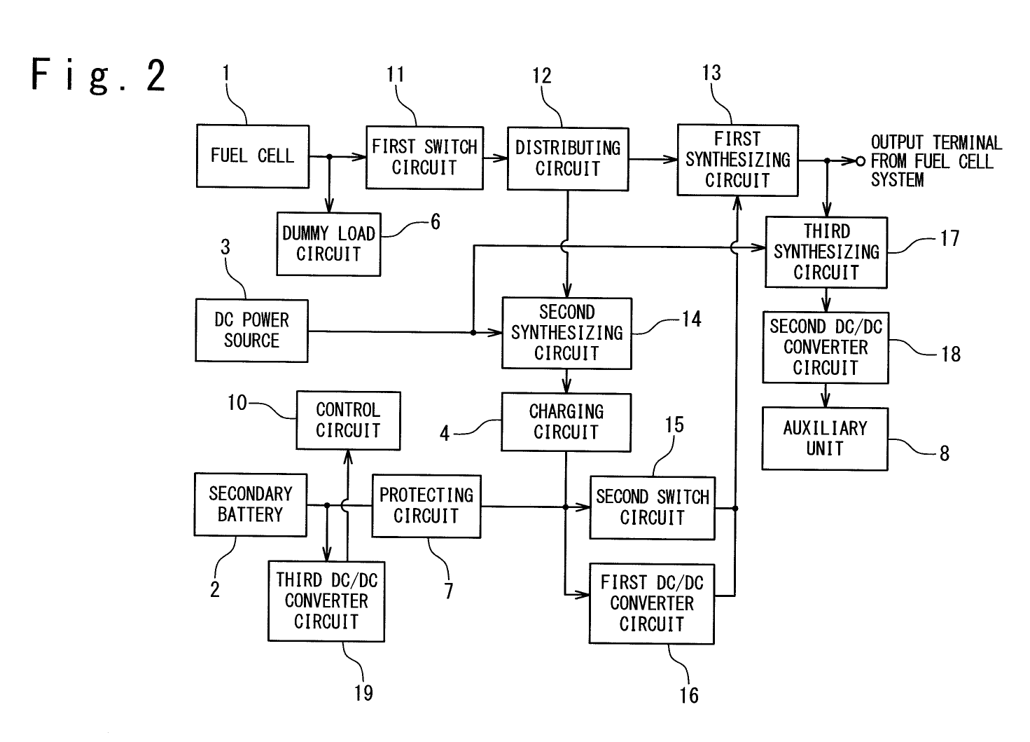

FIG. 2 is a block diagram showing a configuration of the fuel cell system according to a first exemplary embodiment of the present invention. Referring to FIG. 2, the fuel cell system of the first exemplary embodiment includes a fuel cell 1, a secondary battery 2, and a DC power source 3 as power sources. An output of the fuel cell 1 is connected to a dummy load circuit 6 and is connected to an information equipment through a first switch circuit 11, a distributing circuit 12, a first synthesizing circuit 13, and an output terminal. In addition, the output of the fuel cell 1 is connected to a third synthesizing circuit 17 through the first synthesizing circuit 13. The distributing circuit 12 supplies a part of the output of the fuel cell 1 to a second synthesizing circuit 14. An output of the DC power source 3 is connected to the second synthesizing circuit 14 and the third synthesizing circuit 17. An output of the third synthesizing circuit 17 is connected to an auxiliary unit 8 through a second DC/DC converter circuit 18. An output of the second synthesizing circuit 14 is connected to a charging circuit 4. An output of the secondary battery 2 is connected to a third DC/DC converter 19 and an output of the third DC/DC converter 19 is connected to the control circuit 10. Furthermore, the output of the second cell 2 is outputted through a protecting circuit 7. Both of outputs of the charging circuit 4 and the protecting circuit 7 are connected to the first synthesizing circuit 13 through a second switch circuit 15 and a first DC/DC converter circuit 16 which are connected in parallel.

In the fuel cell system of the first exemplary embodiment, the fuel cell 1 is a direct methanol type fuel cell. Also, although the secondary battery 2 is, for example, a lithium-ion secondary battery, it is not limited to this. The DC power source 3 may be omitted in general, but it can operate to supplement the secondary battery 2 when an AC adapter for a personal computer as a load is used as the DC power source, and can allow a charging operation to the secondary battery 2 and an operation of the auxiliary unit 8 by the AC adapter. Each of the first to third synthesizing circuits 13, 14, and 17 is a circuit for synthesizing two or more inputs to output a synthesis result. Each of the first DC/DC converter circuit 16, the second DC/DC converter circuit 17, and the third DC/DC converter circuit 119 is a circuit for converting an input voltage to supply an output voltage. The auxiliary unit 8 is, for example, an electric fan for conveying fuel to the fuel cell 1.

Based on an output from the secondary battery 2, the third DC/DC converter circuit 19 generates a conversion voltage to output to the control circuit 10. As a result, the control circuit 10 can operate. That is to say, the control circuit 15 is always in an operating state regardless of an operating condition of the fuel cell 1. The control circuit 10 controls operations of respective sections in the fuel cell system. For this purpose, the control circuit 10 may store data regarding values of a voltage and a current in the respective sections and regarding an operation of the auxiliary unit 8.

In this state, under the control of the control circuit 10, electric power is supplied from the fuel cell 1 and the DC power source 3 to the auxiliary unit 8 through the third synthesizing circuit 17 and the second DC/DC converter circuit 18, and the auxiliary unit 8 starts its operation. The auxiliary unit 8 is a fan and accordingly the fuel is distributed throughout the fuel cell 1. The fuel cell 1 starts electric power generation by using the fuel and oxidizing agent.

When the fuel is supplied and the fuel cell 1 starts electric power generation, the generated electric power is supplied. The dummy load circuit 6 is a pseudo load, and the electric power is supplied from the fuel cell 1 to the dummy load circuit 6 on trial before actually driving a normal load such as information equipment and the like. A value of electric current flowing supplied to the dummy load circuit 6 at this moment and a value of output voltage of the fuel cell 1 are sent to the control circuit 10. The control circuit 10 controls ON/OFF of the first switch circuit 11 based on these values. The control circuit 10 drives the dummy load circuit 6 in a state that the first switch circuit 11 is turned OFF, and determines a state of the fuel cell 1 based on the data of an output voltage and an output current of the fuel cell 1. When the fuel cell 1 can supply sufficient electric power to the dummy load circuit 6, the control circuit 10 turns ON the first switch circuit 11, and supplies the electric power from the fuel cell 1 to the first synthesizing circuit 13. The second switch circuit 15 and the first DC/DC converter circuit 16 are connected in parallel, and connected to the first synthesizing circuit 5. In such a manner, the electric power synthesized from the electric power of the secondary battery 2 and the electric power of the fuel cell 1 is supplied to a load such as an information equipment.

The dummy circuit 6 may operate as a constant current circuit acting so as to hold the output current of the fuel cell 1 constant. In this case, the dummy load circuit 6 is used for determining whether the fuel cell 1 normally started up or not. The dummy load circuit 6 may be a simple resistance load, and may be a circuit thermally connected with the fuel cell 1. For example, the dummy load circuit 6 may be a heater for warming the fuel cell, but is not limited to the heater. In addition, by detecting data showing a temperature of the fuel cell 1 from a value of an output current of the dummy load circuit 6, the control circuit 10 may control a value of the output current of the fuel cell 1 depending on temperature data. As described above, when the dummy load circuit 6 is a constant current circuit, controlling of the output current of the fuel cell 1 is easy.

Here, while the fuel cell 1 cannot generate a sufficient power because being still in the course of start-up, the control circuit 10 makes the second switch circuit 15 turn ON, and supplies a voltage of the secondary battery 1 to the first synthesizing circuit 13 at almost 100%. On the contrary, when an operation of the fuel cell 1 is stabilized, the control circuit 10 makes the second switch circuit 9 turn OFF, operates the first DC/DC converter circuit 16, and supplies a voltage which is made by lowering the voltage of the secondary battery 1 through conversion for the first synthesizing circuit 5.

In addition, the fuel cell system according to the first exemplary embodiment of the present invention includes the charging circuit 4 which supplies a charging current to the secondary battery 2 based on the output voltage and the output current of the fuel cell 1 in response to an instruction from the control circuit 10. If the fuel cell 1 has a margin in the output power, the control circuit 10 controls the charging circuit 4 to charge the secondary battery 2 through the protecting circuit 7. The control circuit 10 determines whether the fuel cell 1 has such a margin or not based on the output voltage and the output current of the fuel cell 1. In accordance with an instruction from the control circuit 10, the charging circuit 4 generates charging power from an output synthesized from an output of the second synthesizing circuit 14, that is, an output from the fuel cell 1, and an output from the DC power source 3, to charge the secondary battery 2. Further, since a normal load such as an information equipment requires electric power when the output current of the fuel cell 1 is equal to or more than a predetermined value, the control circuit 10 controls the charging circuit 4 to reduce a charging current for charging the secondary battery 2 in order to primarily supply electric power to an outer load. At this time, the control circuit 10 detects the output voltage and the output current of the fuel cell 1 to control a charging current of the charging circuit 4. Specifically, when the output voltage of the fuel cell 1 is equal to or less than a predetermined value (for example, 4.0 V or less), the charging circuit 4 is controlled to reduce the charging current. In addition, when the output voltage of the fuel cell 1 to an information equipment (an outer load) is equal to or more than a predetermined value, the charging circuit 6 is controlled to reduce the charging current.

### Second Exemplary Embodiment

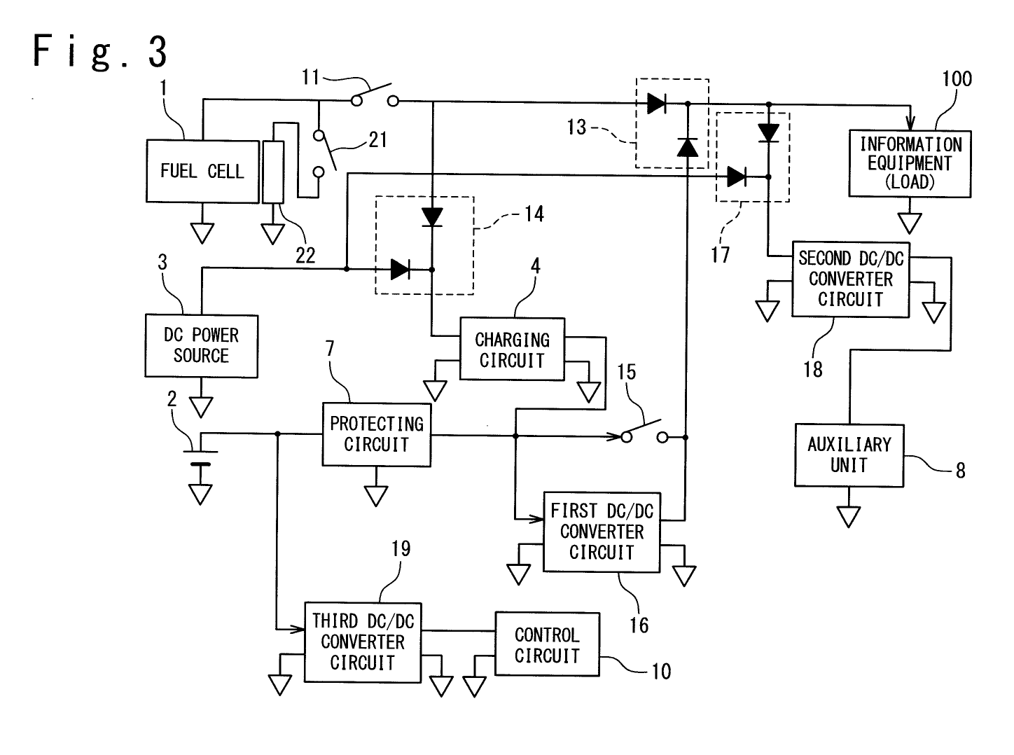

FIG. 3 is a block diagram showing a configuration of the fuel cell system according to a second exemplary embodiment of the present invention. A configuration of the second exemplary embodiment is the same as that of the first exemplary embodiment. Accordingly, only different points will be described.

Referring to FIG. 3, in the fuel cell system of the second exemplary embodiment, the dummy load circuit 6 is replaced by a switch 21 and a load 22. The load 22 is a heater for warming a fuel cell 1. By detecting data showing the temperature of the fuel cell 1 from a value of a current of the load 22, the control circuit 10 controls a value of an output current of the fuel cell 1 depending on temperature data. The distributing circuit 12 is omitted in the second exemplary embodiment. In addition, the first synthesizing circuit 13, the second synthesizing circuit 14, and the third synthesizing circuit 17 are realized by an OR connection of outputs of two diodes, respectively.

The diode may be composed of a schottky barrier diode, a transistor, or an FET depending on an applied load and an application field. Furthermore, instead of diodes, any rectifier circuit may be used, which limits a direction of an electric current flow. As described above, usage of a schottky barrier diode, a transistor, or a FET is intended to reduce losses accompanied by the electric current since forward voltage drop is small.

In this way, an operation of the fuel cell system of the second exemplary embodiment is also the same as that of the first exemplary embodiment.

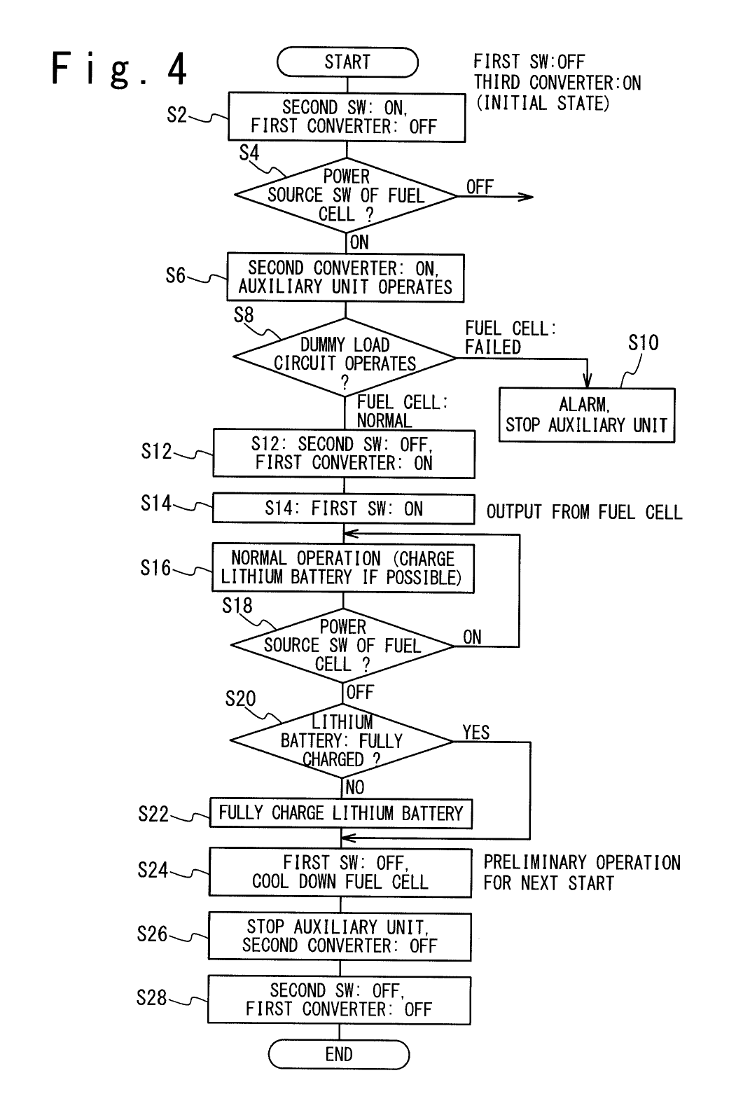

FIG. 4 is a flowchart showing an operation of the fuel cell system of the present invention. In the fuel cell system of the present invention, a personal computer is a load, and an output terminal of the fuel cell system is connected to the personal computer.

A procedure for starting up the fuel cell system of the present invention will be described. In starting of the fuel cell system, the first switch circuit 11 is turned OFF, the third DC/DC converter circuit 19 is turned ON, and the control circuit 10 is in an operating state.

At first, at a step S2, the second switch circuit 15 is turned ON, the first DC/DC converter circuit 16 is turned OFF, and the electric power from the secondary battery 2 is supplied to the first synthesizing circuit 13 through the second switch circuit 15 and then is supplied to a personal computer as a load.

Next, at a step S4, a cell-on instruction is send from a key board of the personal computer to the control circuit 10 to turn on the power source of the fuel cell system of the present invention. At a step S6, the control circuit 10 turns on the second DC/DC converter circuit 18 in response to the cell-on instruction, to start an operation of the auxiliary unit 8. In this manner, supplying of fuel to the fuel cell 1 starts, and an operation of the fuel cell 1 starts. At a step S8, the dummy load circuit 6 also operates at the same time.

Thus, supply of electric power from the fuel cell 1 to the dummy load circuit 6 is performed. When the control circuit 10 determines that the fuel cell 1 has a problem based on data from the dummy load circuit 6, an alarm is outputted so as to stop a function of the auxiliary unit 8 at a step S10. If there is no problem in an electric power supply from the fuel cell 1 to the dummy load circuit 6, the control circuit 10 turns off the second switch circuit 15, turns on the first DC/DC converter circuit 16, and stops a part of supply of electric power from the secondary battery 2 to the personal computer. Thus, only a part of electric power is supplied to the personal computer. At the same time, the control circuit 10 turns on the first switch circuit 11 at a step S14. As a result, the supply of electric power from the fuel cell 1 to the personal computer starts.

According to the above-mentioned procedure, the fuel cell system performs a normal operation. The control circuit 10 determines whether there is a margin in an output of the fuel cell 1 or not at a step S16. If there is a margin, the control circuit 10 controls the charging circuit 4 to charge the secondary battery 2 through the distributing circuit 12, the second synthesizing circuit 14, and the charging circuit 4.

Next, an operation for stopping the fuel cell system will be described. First, an instruction is sent from the keyboard of the personal computer to the control circuit 10 at a step S18 to turn off the fuel cell system of the present invention. In response to this cell-off instruction, the control circuit 10 determines whether the secondary battery 2 is in a fully charged state or not at a step S20. In case where the secondary battery 2 in not in a fully charged state, the control circuit 10 continuously performs charging to the secondary battery 2 through the distributing circuit 12, the second synthesizing circuit 14, and the charging circuit 4 at a step S22. When the secondary battery 2 becomes a fully charged state at a step S24, the control circuit 10 turns off the first switch circuit 11, and sets an operation of the fuel cell 1 to a cooling down state. At a step S26, the control circuit 10 turns off the second DC/DC converter circuit 18 in termination of the cooling down state of the fuel cell 1. At the same time, the control circuit 10 turns off the auxiliary unit 8. Subsequently, at a step S28, the control circuit 10 turns off the second switch circuit 15, and turns off the first DC/DC converter circuit 16.

As clearly understood from the above description, the control circuit 10 is always in an operating state regardless of an operating condition of the fuel cell 1, and controls the system normally.

### Third Exemplary Embodiment

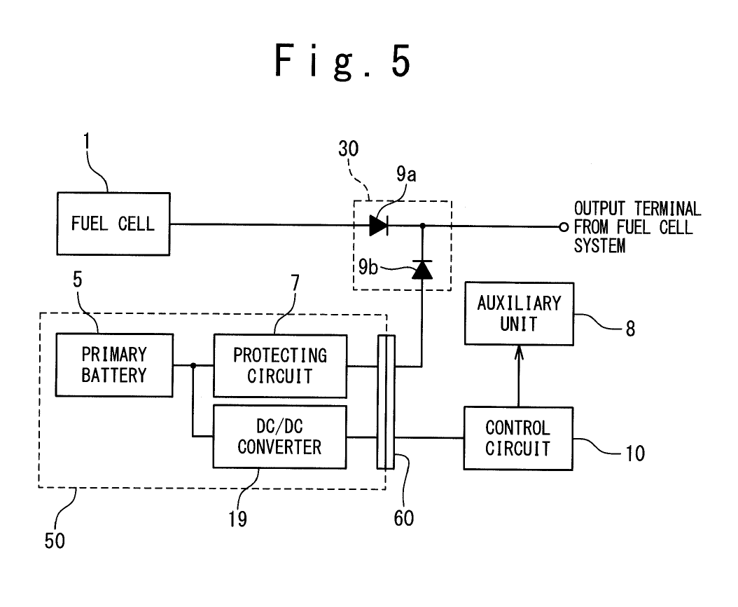

Next, the fuel cell system according to a third exemplary embodiment of the present invention will be described. Referring to FIG. 5, the fuel cell system of the third exemplary embodiment includes the fuel cell 1, a synthesizing circuit 30, the auxiliary unit 8, and the control circuit 10. An assisting power source pack 50 is connected to the fuel cell system through a connector 60. The synthesizing circuit 30 is formed of diodes, and synthesizes the electric power from the fuel cell 1 and the electric power from the assisting power source pack 50 to supply to a load such as a personal computer. The assisting power source pack 50 includes a primary battery 5, the protecting circuit 7, and a DC/DC converter 13.

The fuel cell system of the present exemplary embodiment is a system employing a fuel cell as a power source. The direct methanol type fuel cell is suitable for the fuel cell 1, but the present invention is not limited to this. The assisting power source pack 50 is connected detachably to the connector 60. As the protecting circuit 7, an electric current sensor for detecting an over-current or a temperature sensor is used. When an output of the fuel cell 1 is less than the required electric power, a shortage of electrical power is supplied from the primary cell 5 of the assisting power source pack 50. In addition, the assisting power source pack 50 performs an ON/OFF control of an output voltage by determining whether an output voltage is lower than a predetermined threshold or not. In addition, a result of the ON/OFF control to the control circuit 10 is sent. Furthermore, the control circuit 10 can perform the ON/OFF control to an output of the assisting power source pack 50.

In the fuel cell system according to the third exemplary embodiment of the present invention, a primary battery 5 having the protecting circuit 7 is used for the assisting power source pack 50. In case of the direct methanol type fuel cell 1, it is required to operate the auxiliary unit 8 such as a pump, and the electric power to be used for control thereof is supplied to the control circuit 10 from the DC/DC converter 13 of the assisting power source pack 50. Thus, even when the protecting circuit 7 operates based on an over-current and an output from the assisting power source pack 50 is turned off, the control circuit 10 can operate, and an appropriate processing can be performed even if in an abnormal value.

In addition, in the fuel cell system according to the third exemplary embodiment of the present invention, the electric power from the fuel cell 1 and the electric power from the primary cell 5 are synthesized by the synthesizing circuit 30, and the synthesis resultant power is supplied to a load such as a personal computer. Furthermore, the synthesis resultant power is supplied to the control circuit 10 from the DC/DC converter 13 through the connecter 60. According to a configuration of FIG. 5, even when the protecting circuit 7 operates based on an over-current and electric power from the assisting power source pack 50 to the synthesizing circuit 30 is turned off, the control circuit 10 can operate by using the DC/DC converter 13, and an appropriate processing can be performed.

### Fourth Exemplary Embodiment

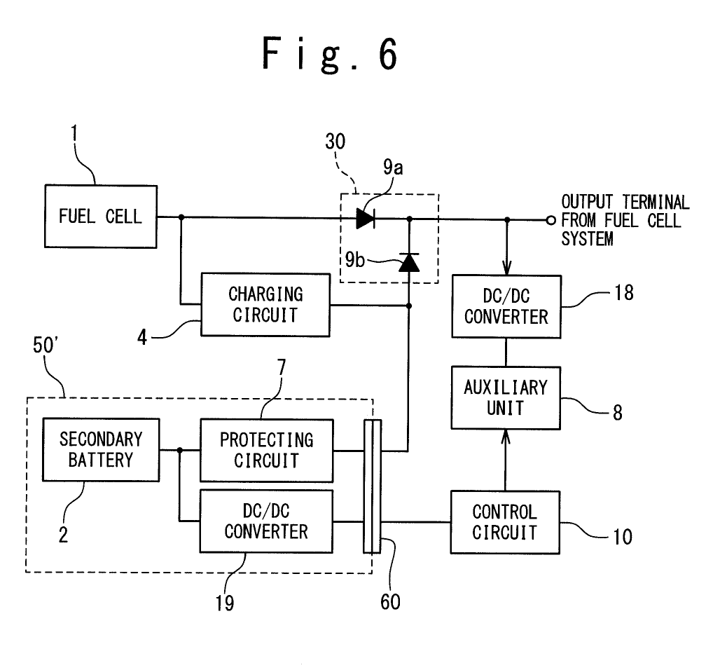

Next, the fuel cell system according to a fourth exemplary embodiment of the present invention will be described. FIG. 6 is a block diagram showing a configuration of the fuel cell system of the fourth exemplary embodiment. Referring to FIG. 6, the fuel cell system according to the fourth exemplary embodiment has the same configuration as that of the fuel cell system of the third exemplary embodiment. Accordingly, only different points will be described. In the fourth exemplary embodiment, an assisting power source pack 50′ is used instead of the assisting power source pack 50. In the assisting power source pack 50′, a lithium-ion secondary battery 2′ is used instead of the primary cell 5. Other components are the same as those of the assisting power source pack 50. In addition, in the fourth exemplary embodiment, the charging circuit 4 is provided between an output of the fuel cell 1 and an input on the assisting power source pack 50′ side of the synthesizing circuit 30 in order to charge the secondary battery 2 in the assisting power source pack 50′. The charging circuit 4 is controlled by the control circuit 10. Furthermore, electric power of the auxiliary unit 8 is supplied from an output of the synthesizing circuit 30 through the DC/DC converter circuit 18. The DC/DC converter circuit 18 is also controlled by the control circuit 10.

Referring to FIG. 6, the electric power from the fuel cell 1 and the electric power from the secondary battery 2 are synthesized by the synthesizing circuit 30, and the synthesis resultant power is supplied to a load such as a personal computer. In addition, in the fuel cell system of the fourth exemplary embodiment, the secondary battery 2 can be always charged from the fuel cell 1 through the charging circuit 11 and the protecting circuit 7. Since the auxiliary unit 8 such as a pump is considered to consume relatively large electric power, the electric power for controlling the auxiliary unit 8 is supplied from the fuel cell 1 through the DC/DC converter 13.

The electric power is supplied from the secondary battery 2 to the synthesizing circuit 30 through the protecting circuit 7 and the connector 60, and the synthesis electric power is supplied to the control circuit 10 from the DC/DC converter 13 through the connector 60. According to a configuration of FIG. 6, even when the protecting circuit 7 operates based on an over-current and the electric power from the assisting power source pack 50′ to the synthesizing circuit 30 is turned off, the control circuit 10 can operate based on the electric power from the DC/DC converter 13, and an appropriate processing can be performed even if in an abnormal state.

### Fifth Exemplary Embodiment

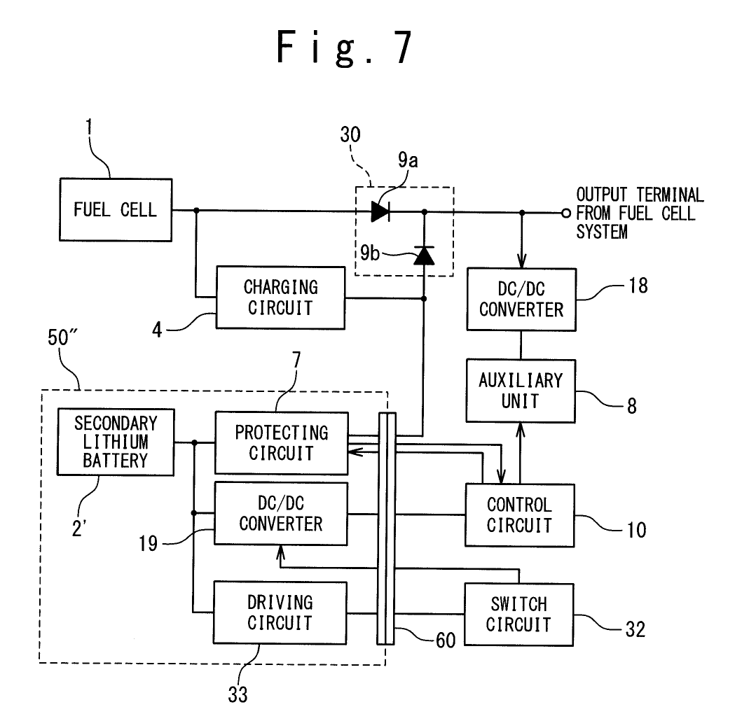

Next, the fuel cell system according to a fifth exemplary embodiment of the present invention will be described. FIG. 7 is a block diagram showing a configuration of the fuel cell system according to the fifth exemplary embodiment. Referring to FIG. 7, the fuel cell system according to the fifth exemplary embodiment has the same circuit configuration as that of the fourth exemplary embodiment. That is to say, the fuel cell system of the fifth exemplary embodiment includes the fuel cell 1, the charging circuit 4, the synthesizing circuit 30, the DC/DC converter circuit 18, the auxiliary unit 8, the switch circuit 32, and the control circuit 10. An assisting power source pack 50″ is connected to the fuel cell system through the connector 60. The synthesizing circuit 30 is formed of diodes, and synthesizes the electric power from the fuel cell 1 and the electric power from the assisting power source pack 50″ to supply to a load such as a personal computer. The assisting power source pack 50″ includes a lithium-ion secondary battery 2′, the protecting circuit 7, the DC/DC converter 13, and a DC/DC converter 33.

The secondary battery 2′ is connected to the synthesizing circuit 30 through the protecting circuit 7 and the connector 60. An output of the synthesizing circuit 30 is connected to the DC/DC converter circuit 18 in addition to a load. The DC/DC converter circuit 18 converts the electric power outputted from the synthesizing circuit 30 to supply to the auxiliary unit 8. In addition, the charging circuit 4 is provided between an output of the fuel cell 1 and an input on the assisting power source pack 50″ side of the synthesizing circuit 30, and always charges the secondary battery 2′. The DC/DC converter circuit 19 converts the electric power from the secondary battery 2′ to supply to the control circuit 10. Thus, the control circuit 10 is in an operating state. The control circuit 10 receives data from the protecting circuit 7, regarding an existence or a nonexistence of an output from the assisting power source pack 50″, and outputs an instruction to the protecting circuit 7 to control an output from the assisting power source pack 50″. The DC/DC converter 33 converts the electric power from the secondary battery 2′ to supply to the switch circuit 32. The switch circuit 32 controls ON/Off of the DC/DC converter circuit 19 by being operated. Thus, an operation of the auxiliary unit 8 can be controlled by the control circuit 10.

Referring to FIG. 7, the switch circuit 32 of the fuel cell system is provided to suppress the electric power consumption as low as possible when a user does not use a power source. An operation of the DC/DC converter circuit 19 is controlled through ON/OFF of the switch circuit 32, thereby operation/stop of the control circuit 10 can be controlled. In this case, however, the DC/DC converter circuit 33 is required which is designed to drive the switch circuit 32 of the fuel cell system in low power consumption. The DC/DC converter circuit 33 is provided for the assisting power source pack 50″ to allow this electrical power to be taken out from the assisting power source pack 50″.

In case where it is required to shut down the assisting power source pack 50″ in safety depending on a state of the fuel cell system, for example, in case where there is a high risk that the assisting power source pack 50″ heats up through overcharging due to a trouble in the charging circuit 4, a circuit for shutting down an output from the assisting power source pack 50″ is required. In the fifth exemplary embodiment, ON/OFF of the protecting circuit 7 can be controlled by the control circuit 10 since there is the protecting circuit 7 in the assisting power source pack 50″. In addition, in case where the control circuit 10 and the charging circuit 4 operate, the control circuit 10 cannot distinguish whether the protecting circuit 7 is ON or OFF. The control circuit 10 can know whether the protecting circuit 7 is ON or OFF, depending on a signal from the protecting circuit 7.

It should be noted that the first to fifth exemplary embodiments described above can be combined in a range in which inconsistence is not caused.

As described above, according to the fuel cell system of the present invention, an optimum control can be performed depending on a state of the fuel cell in case where the auxiliary unit is arranged and an assisting power source is required. In addition, the electric power can be always supplied from the assisting power source other than the fuel cell so that a control circuit cannot be shut down.

1. A fuel cell system comprising:
a fuel cell configured to generate an electric power based on fuel;
a first assisting power source;
a protecting circuit connected to said first assisting power source and configured to detect a failure in said first assisting power source;
an auxiliary unit configured to supply said fuel to said fuel cell;
a control circuit configured to control said fuel cell and said auxiliary unit;
a first power converter configured to drive said control circuit based on an electric power from said first assisting power source; and
a first synthesizing section configured to synthesize a first electric power as the electric power from said fuel cell and a second electric power as the electric power from said first assisting power source to supply a synthesis power to a load.

2. The fuel cell system according to claim 1, wherein said first assisting power source is a secondary battery,
said fuel cell system further comprises:
a charging circuit provided between said fuel cell and said protecting circuit to charge said secondary battery based on the electric power from said fuel cell, and
said control circuit controls said charging circuit based on the electric power from said fuel cell.

3. The fuel cell system according to claim 1, wherein said first assisting power source is a primary battery.

4. The fuel cell system according to claim 1, further comprising:
a dummy load circuit connected to an output of said fuel cell; and
a first switch circuit connected between the output of said fuel cell and said dummy load circuit,
wherein when it is determined based on said dummy load circuit that the output of said fuel cell is within a predetermined range, said control circuit turns on said first switch circuit.

5. The fuel cell system according to claim 4, wherein said dummy load circuit comprises:
a heater configured to heat said fuel cell; and
a second switch circuit connected between the output of said fuel cell and said heater, and
said control circuit controls on/off of said second switch circuit based on a temperature of said fuel cell.

6. The fuel cell system according to claim 1, further comprising:
a second electric power converter configured to perform electric power conversion on the electric power from said first assisting power source to supply the second electric power to said first synthesizing section; and
a third switch circuit provided in parallel to said second electric power converter and configured to supply the electric power from said first assisting power source as the second electric power to said first synthesizing section,
wherein said control circuit turns on said third switch circuit and turns off said second electric power converter, in a first predetermined period, and turns off said third switch circuit and turns on said second electric power converter, in a period other than the first predetermined period.

7. The fuel cell system according to claim 1, wherein said control circuit supplies electric power to said auxiliary unit.

8. The fuel cell system according to claim 1, further comprising:
a third electric power converter connected to an output of the first synthesizing section and configured to supply the electric power to said auxiliary unit through an electric power conversion.

9. The fuel cell system according to claim 1, wherein said first assisting power source, said protecting circuit, and said first electric power converter constitute an electric source pack which is detachably connected to a connector of said fuel cell system.

10. The fuel cell system according to claim 1, further comprising:
a DC power source;
a charging circuit provided between said fuel cell and said protecting circuit and configured to charge said secondary battery;
a third electric power converter connected to an output of said first synthesizing section and configured to supply the synthesis electric power to said auxiliary unit through an electric power conversion;
a second synthesizing section connected to an input of said first synthesizing section and said DC power source and configured to synthesize the electric power from said fuel cell and an electric power from said DC power source to supply to said charging circuit; and
a third synthesizing section connected to the output of said first synthesizing section and said DC power source and configured to synthesize the electric power from said fuel cell and the electric power from said DC power source to supply to said third electric power converter.

11. The fuel cell system according to claim 1, further comprising:
a DC electric power;
a third electric power converter connected to the output of said first synthesizing section and configured to supply an electric power to said auxiliary unit through an electric power conversion; and
a third synthesizing section connected to an output of said first synthesizing section and said DC power source and configured to synthesize the electric power from said fuel cell and an electric power from said DC power source to supply to said third electric power converter.

12. A control method of a fuel cell system, comprising:
detecting a failure of a first assisting power source;
turning on a control circuit by said first assisting power source when the failure of said first assisting power source is not detected;
supplying an electric power from said first assisting power source to a load under a control of said control circuit;
turning on a fuel cell in response to a cell-on instruction;
driving an auxiliary unit to supply fuel to said fuel cell;
determining whether an operation of said fuel cell is normal or not;
stopping a supply of the electric power from said first assisting power source when it is determined that the operation of said fuel cell is normal; and supplying an electric power from said fuel cell to said load.

13. The control method according to claim 12, wherein a first assisting power source is a secondary battery, and
said control method further comprises:
charging said first assisting power source by a charging circuit when it is determined by said control circuit that there is a margin in electric power supplied from said fuel cell to said load.

14. The control method according to claim 13, further comprising:
determining whether said first assisting power source is fully charged or not in response to a cell-off instruction;
fully charging said first assisting power source when it is determined to be not fully charged;
disconnecting said fuel cell from said load; and
stopping supply of the fuel to said fuel cell.
